(19) United States
(12) Patent Application Publication
(10) Pub. No.: US 2002/0120758 A1
(43) Pub. Date: Aug. 29, 2002

(54) IP packetized frame format in a passive optical network

(75) Inventor: Tsung-Shien Chang, San-Wan Shin (TW)

Correspondence Address: Ya-Chiao Chang, 9 South Wickom Drive, Westfield, NJ, 07090, US

(73) Assignee: Glory Telecommunications C0., Ltd.

(21) Appl. No.: 09/792,309

(22) Filed: Feb. 23, 2001

(51) Int. Cl. G06F 15/16

(52) U.S. Cl. 709/230; 709/251

(57) ABSTRACT

In a passive optical network (PON) connected to an Internet protocol (IP) network where the PON includes an optical line terminal (OLT), a plurality of optical network units (ONUs) connected to the OLT, a preferred embodiment of the invention provides an upstream frame for transmitting data from one of the ONUs to the OLT. The upstream frame comprises a preamble alerting the OLT of the upstream frame, a start frame delimiter (SFD) indicating a start of the frame, a header indicating the ONU from which the frame is transmitted, a ranging time stamp responding to a ranging time clock sent from the OLT, a churning key performing churning for the PON, a leased channel transporting data to the OLT, a voice time division multiple access (TDMA) channel transporting local call voice data to the OLT, a voice over Internet protocol (VOIP) channel transporting long distance call voice data to the IP network, a data packet transporting data packets to the IP network, and an end frame delimiter (EFD) indicating an end of the frame. In the downstream, the PON comprises a downstream frame for transmitting data from the OLT to the ONUs, the downstream frame comprising a preamble alerting the ONU of the frame, an SFD indicating a start of the frame, a header indicating the OLT from which the frame is transmitted, a ranging time stamp sending a ranging time clock to the ONUs, a churning control performing a churning key request for the PON, a data packet transporting data packets from the IP network to the ONUs, an EFD indicating an end of the frame, and a plurality of ONU fields corresponding to each of the ONUs. Each of the ONU fields comprises an ONU header indicating a start of the ONU field, a leased channel transporting data to the ONU corresponding to the ONU field, a voice TDMA channel transporting local call voice data to the ONU corresponding to the ONU field, and a voice VOIP channel transporting long distance call voice data from the IP network to the ONU corresponding to the ONU field.

### BACKGROUND OF THE INVENTION

1. Field of the Invention

The invention relates to optical networks and, more particularly, to the format of an Internet-protocol (IP) packetized frame in a passive optical network (PON).

2. Description of the Related Art

A passive optical network (PON) is an optical network that does not employ, or reduces the use of, active devices such as lasers, regenerators and amplifiers. A PON includes an optical line terminal (OLT), located at the central office (CO) or cable headend, connected to a plurality of optical network units (ONUs). Because of the reduction in the number of active devices, the optical network can improve performance and become more cost-effective in operation and maintenance.

A PON can employ a tree, bus or ring architecture in connecting the single OLT with the ONUs. FIG. 1 is a block diagram generally illustrating a PON with an OLT 11 connected to ONUs 111, 112, 113, 114 and 115 in a ring architecture. FIG. 2 is a block diagram generally illustrating a PON with an OLT 21 connected to ONUs 211, 212, 213, 214 and 215 in a tree architecture. FIG. 3 is a block diagram generally illustrating a PON with an OLT 31 connected to ONUs 311, 312, 313, 314, 315 and 316 in a bus architecture. Data travels upstream when the data are transmitted from the ONUs to the OLT. Data travels downstream when the data are transmitted from the OLT to the ONUs. The OLT can also be connected to another network, e.g., network 110, 210 and 310 respectively, such as another optical or non-optical network.

The performance of optical networks in delivering information (e.g., broadband voice, data and video services to end users) can also be exploited in non-optical networks such as the Internet or in applications based on the Internet protocol (IP). IP, a protocol widely used in the art, specifies the format of packets (also called datagrams in IP networks) and the associated addressing scheme. A packet is a piece of a message transmitted over a packet-switching network (such as an IP network) where the packet includes the destination address in addition to the data, and each packet in the network is transmitted individually (which can follow different routes) to its corresponding destination.

A general need therefore exists for conforming data frames (a frame being a packet of transmitted information) of the optical network for transmission over IP-based networks such as the Internet. In particular, a need exists in the art for conforming data frames of a PON with data transmission in IP applications.

### SUMMARY OF THE INVENTION

In a passive optical network (PON) connected to an Internet protocol (IP) network where the PON includes an optical line terminal (OLT), a plurality of optical network units (ONUs) connected to the OLT, a preferred embodiment of the invention provides an upstream frame for transmitting data from one of the ONUs to the OLT. According to this embodiment, the upstream frame comprises an upstream preamble alerting the OLT of the upstream frame, an upstream start frame delimiter (SFD) indicating a start of the upstream frame, an upstream header indicating the ONU from which the upstream frame is transmitted, an upstream ranging time stamp responding to a ranging time clock sent from the OLT, a churning key performing churning for the PON, a leased channel transporting data to the OLT, a voice time division multiple access (TDMA) channel transporting local call voice data to the OLT, a voice over Internet protocol (VOIP) channel transporting long distance call voice data to the IP network, a data packet transporting data packets to the IP network, and an upstream end frame delimiter (EFD) indicating an end of the upstream frame.

In the downstream, the PON further comprises a downstream frame for transmitting data from the OLT to the ONUs, the downstream frame comprising a downstream preamble alerting the ONU of the downstream frame, a downstream start frame delimiter (SFD) indicating a start of the downstream frame, a downstream header indicating the OLT from which the downstream frame is transmitted, a downstream ranging time stamp sending a ranging time clock to the ONUs, a churning control performing a churning key request for the PON, a downstream data packet transporting data packets from the IP network to the ONUs, a downstream end frame delimiter (EFD) indicating an end of the downstream frame, and a plurality of ONU fields corresponding to each of the ONUs. Each of the ONU fields comprises an ONU header indicating a start of the ONU field, a leased channel transporting data to the ONU corresponding to the ONU field, a voice time division multiple access (TDMA) channel transporting local call voice data to the ONU corresponding to the ONU field, and a voice over Internet protocol (VOIP) channel transporting long distance call voice data from the IP network to the ONU corresponding to the ONU field.

With the upstream and downstream data frame format according to the invention, the transmission of data frames for an optical network (particularly a passive optical network or PON) over IP-based networks such as the Internet is efficiently and advantageously achieved.

### BRIEF DESCRIPTION OF THE DRAWINGS

The foregoing and other advantages and features of the invention will become more apparent from the detailed description of the preferred embodiments of the invention given below with reference to the accompanying drawings, not necessarily drawn to scale, in which:

FIG. 1 is a diagram generally illustrating a passive optical network (PON) in the art with a ring architecture;

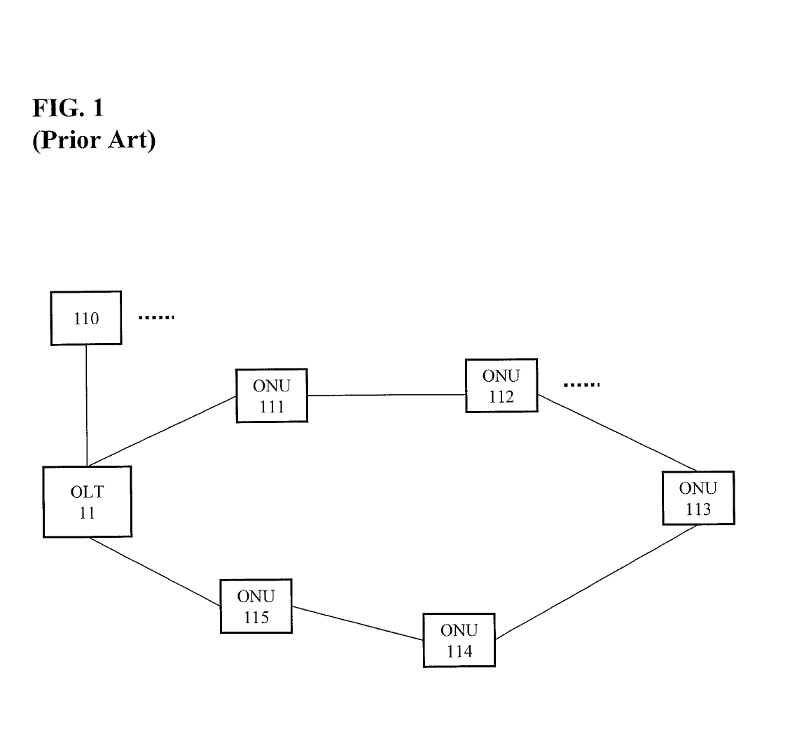

FIG. 2 is a diagram generally illustrating a passive optical network (PON) in the art with a tree architecture;

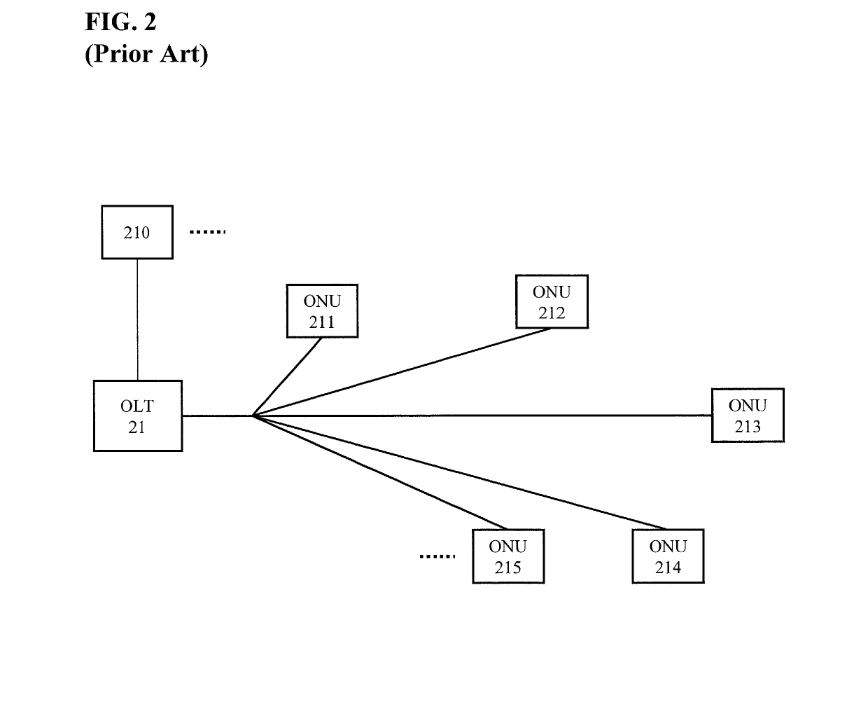

FIG. 3 is a diagram generally illustrating a passive optical network (PON) in the art with a bus architecture;

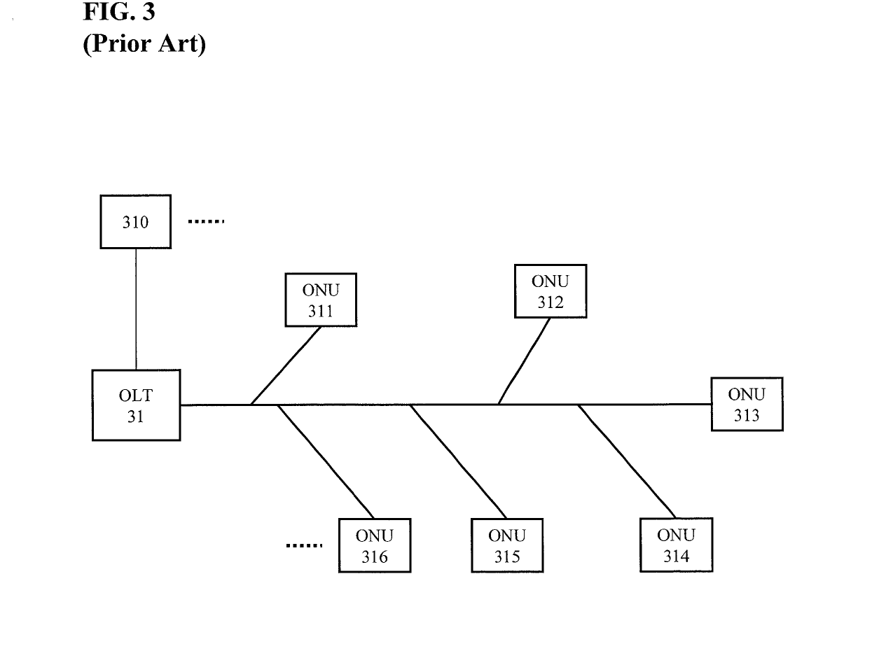

FIG. 4 is a diagram generally illustrating a passive optical network (PON) using a data frame according to the invention;

FIG. 5 is a diagram illustrating an upstream data frame according to the invention;

FIG. 6 is a diagram illustrating a leased channel for an upstream data frame according to the invention;

FIG. 7 is a diagram illustrating a voice TDMA channel for an upstream data frame according to the invention;

FIG. 8 is a diagram illustrating the relationship between the bit position and the port number in the user port identification fields of a voice TDMA channel for an upstream data frame according to the invention;

FIG. 9 is a diagram illustrating an exemplary data structure of a voice TDMA channel for an upstream data frame according to the invention;

FIG. 10 is a diagram illustrating a voice VOIP channel for an upstream data frame according to the invention;

FIG. 11 is a diagram illustrating an upstream data packet channel for an upstream data frame according to the invention;

FIG. 12 is a diagram illustrating a downstream data frame according to the invention; and

FIG. 13 is a diagram illustrating an optical network unit (ONU) header for a downstream data frame according to the invention.

### DETAILED DESCRIPTION OF THE PREFERRED EMBODIMENTS

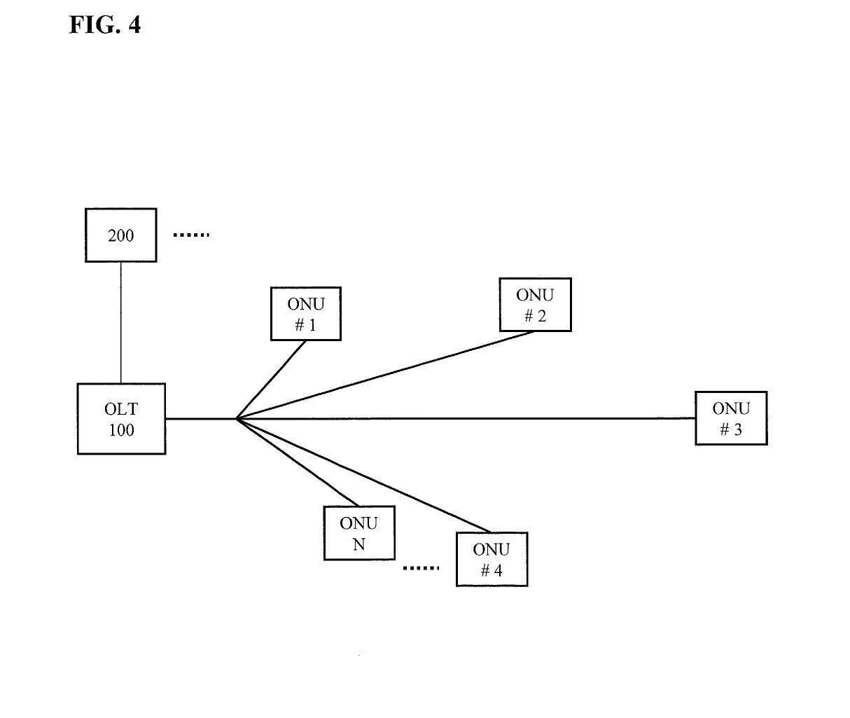

FIG. 4 is a block diagram that generally illustrates a passive optical network (PON) with an optical line terminal (OLT) 100 connected to an Internet protocol (IP) network 200. The OLT 100 is connected to a plurality of optical network units (ONU 1, 2, 3, 4, . . . and N, N being an integer) in a ring, tree or bus architecture. FIG. 4 particularly shows the PON in a tree architecture. The PON according to the invention, which can include a ring or bus architecture, is not limited to a tree architecture. The invention is described herein in conjunction with the PON shown in FIG. 4.

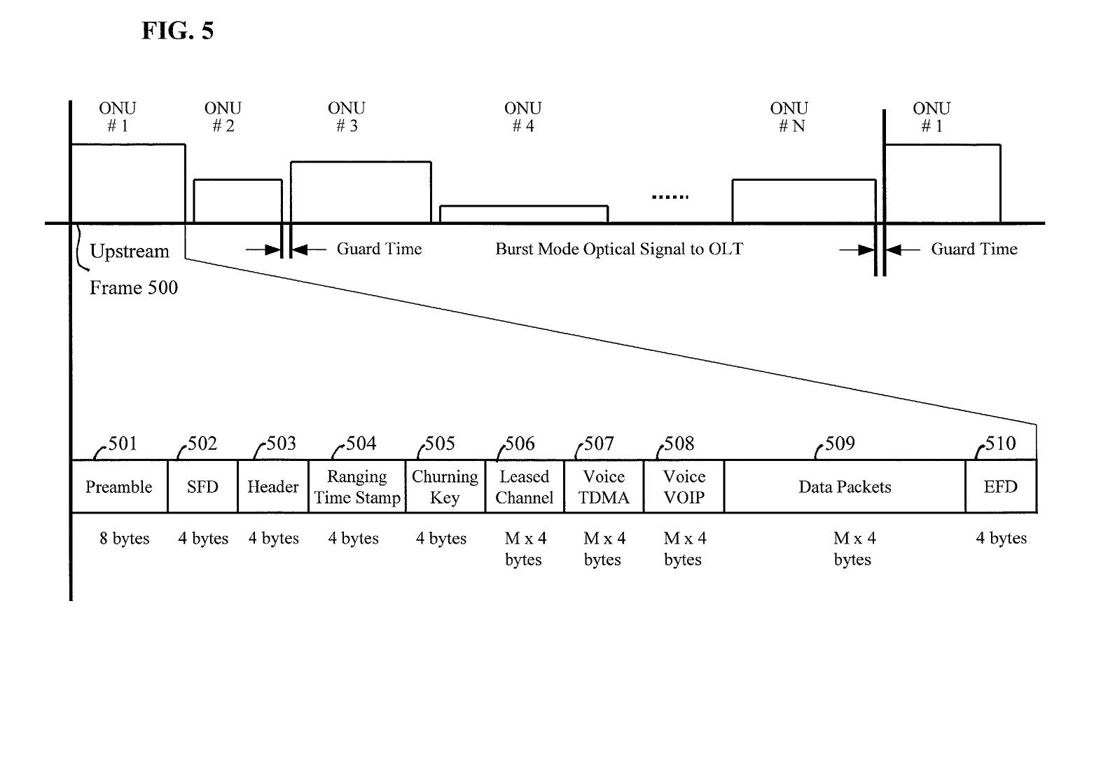

FIG. 5 is a diagram that illustrates an upstream frame 500 for carrying data or information upstream from the ONU 1 to the OLT 100 in accordance with the invention. The upstream frame format for the other ONUs (ONU 2, 3, 4, . . . and N) are generally the same as the upstream frame 500 for ONU 1. In an exemplary embodiment of the invention, the upstream frames, each frame carrying data for each of the ONUs, travel in succession and separated by a guard time between two frames. In the present embodiment, the upstream frames travel to the OLT 100 in a burst mode, which is a data transmission mode in which the data are sent faster than normal.

The upstream frame 500 comprises ten fields, including an upstream preamble 501, an upstream start frame delimiter (SFD) 502, an upstream header 503, an upstream ranging time stamp 504, a churning key 505, a leased channel 506, a voice time division multiple access (TDMA) channel 507, a voice over Internet protocol (VOIP) channel 508, an upstream data packet channel 509, and an upstream end frame delimiter (EFD) 510.

The preamble 501 contains 8 bytes (64 bits) of alternating 1s and 0s that alert the OLT 100 to the coming upstream frame 500 and enables the synchronization of its timing. The SFD 502, at 4 bytes, is used as a frame alignment signal to indicate the start of the upstream frame 500.

The header 503 is used for the system control of the PON that identifies the ONU 1 from which the data are being transmitted and specifies the undelivered data block in the ONU 1. The header 503 includes an ONU identifier (1 byte) that indicates the ONU number on the PON, another byte K1 used for the protection switch function for the PON, and an undelivered data block (UDB) of 2 bytes with automatic bandwidth adjustment.

The ranging time stamp 504 (4 bytes) is used to return the ranging time clock sent from the OLT 100. The ONU 1 copies the ranging time clock received from the OLT 100 and stores it into the ranging time stamp 504 for the ONU 1. The OLT 100 calculates the timing difference (i.e., the round trip time) between the receiving time, the ranging time stamp received from the ONU 1, and the time of the ranging time stamp for adjusting the guard time between two ONUs, e.g., the ONUs 1 and 2. The ranging time stamp 504 can also be used for automatic bandwidth adjustment. For example, if the sending time is 212 μS for a frame sent from the OLT then copied back to the OLT by the ONU, with the receiving time at 378 μS, the round trip time is 378 minus 212 which is 166 μS.

The churning key 505 (4 bytes) is used for performing the churning function of the PON. Churning refers to the encryption of transmission channels in the art.

The leased channel 506 is a M×4-byte field (M being an integer) which is used to transport data, such as time division multiplexing (TDM) or IP data to the OLT 100 or the IP network 200. A leased channel or leased line is a generally permanent and constantly active connection between two points set up by a telecommunications common carrier, e.g., a T-1, T-3, DS1, E1, DS3, or E3 channel for accessing the Internet. A T-1 channel (sometimes referred to as a DS1 channel) is a dedicated telephone connection supporting transmission data rates of generally 1.544 megabits per second (Mbps). A T-3 channel (sometimes referred to as a DS3 channel) is a dedicated telephone connection supporting transmission data rates of generally 44.736 Mbps. Moreover, an E-1 channel is a dedicated telephone connection supporting transmission data rates of generally 2.048 Mbps. An E-3 channel is a dedicated telephone connection supporting transmission data rates of generally 34.368 Mbps.

The voice TDMA channel 507, an M×4-byte field where M is an integer, is used to transport local call voice data packets to the OLT 100. Time division multiple access or TDMA is a technology for delivering digital wireless service using time division multiplexing or TDM. TDMA works by dividing a radio frequency into time slots and allocating the slots to multiple calls (such as local calls), thereby allowing a single frequency to support multiple, generally simultaneous data channels.

Note that TDM is a type of multiplexing that combines data streams by assigning each stream a different time slot in a set. TDM repeatedly transmits a fixed sequence of time slots over a single transmission channel.

The voice VOIP channel 508, an M×4-byte field, is used to transport long distance call data packets to the Public Switched Telephone Network (PSTN) or the IP network 200. PSTN refers to the international telephone system based on copper wires carrying analog voice data. Voice over Internet protocol or VOIP is a type of Internet telephony (i.e., an Internet telephony application over the Internet protocol) which is a category of hardware and software that enable end users to use the Internet as the transmission medium for telephone calls.

The upstream data packet channel 509, an M×4-byte field where M is an integer, is used to transport the data packets with lower priority (such as computer data files or image pictures) over the IP network 200. The end frame delimiter (EFD) 510, a 4-byte field (9E, 9E, 9E and 9E in hexadecimal) is used as a frame termination signal to indicate the end of the upstream frame 500.

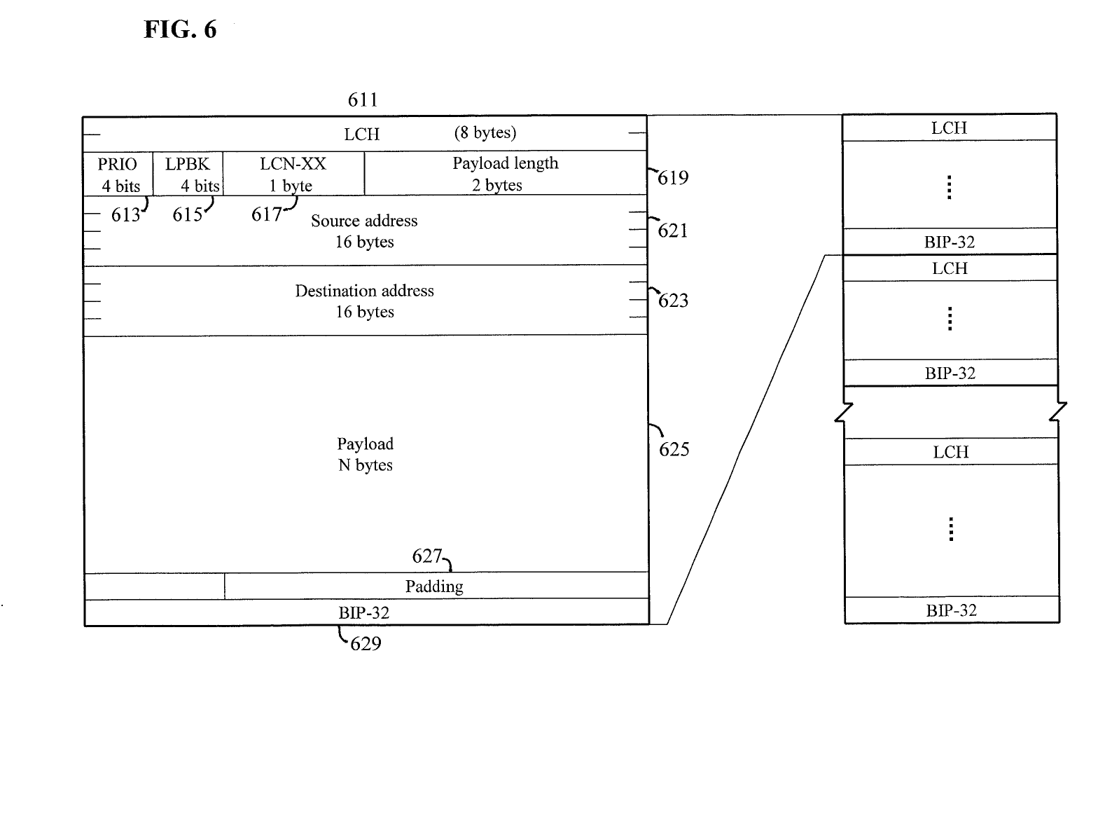

The leased channel 506, voice TDMA channel 507, voice VOIP channel 508 and the upstream data packet channel 509 are described in further detail below in conjunction with FIGS. 6-11.

FIG. 6 is a diagram that illustrates the leased channel 506 for the upstream frame 500. The leased channel 506 is a M×4-byte field (M being an integer) which is used to transport data, such as time division multiplexing (TDM) or IP data to the OLT 100 or the IP network 200. The leased channel 506 comprises a plurality of fields including the leased channel header (LCH) 611, the priority (PRIO) 613, the loopback (LPBK) 615, the LCN 617, the payload length 619, the source address 621, the destination address 623, the payload 625, the padding 627 and the bit interleaved parity 32 (BIP-32) 629.

The LCH 611, an 8-byte field (8E, F6, 8E, 28 in hexadecimal), indicates the start of the leased channel 506. The PRIO 613, a 4-bit field, defines the priority level and the payload type of the data packets with respect to data traffic flow. A value of 0 for the PRIO 613 indicates the lowest priority. A value of 15 (or F in hexadecimal) indicates the highest priority. For instance, the priority value for the leased channel 506 is 14, for the voice TDMA channel 507 is 13, for the voice VOIP channel 508 is 12, for image data is 11. Data files can be at a lower priority level.

The LPBK 615, a 4-bit field, defines the loopback function of the leased channel 506. The LCN 617, a 1-byte field, is a reserved channel. The payload length 619, a 2-byte field, defines the total payload length of leased channel 506. The payload length 619 does not include padding 627 and the bit interleaved parity 32 (BIP-32) 629.

The source address 621, a 16-byte IP address, identifies the original source of the data being transported. The destination address 623, also a 16-byte IP address, identifies the final destination of the data being transmitted, e.g., the IP network 200. However, if source routing is used, the destination address 623 includes the IP address of the next entity to which the data are being transported, e.g., the OLT 100, the ONUs, the IP network, other OLT and ONUs of another PON.

The payload 625, an N-byte field (N being an integer), includes the payload of the TDM data packets. If the TDM payload comes from an asynchronous network (such as an asynchronous transfer mode or ATM network), the total payload length could be (N×4)+y bytes (y=0, 1, 2, 3) so that the padding data are needed to make the data packets at N×4 bytes. Padding is used for filling in unused space, where the padding 627 is used to meet the requirement at N×4 bytes for the field of the payload 625. Note that ATM is a network technology based on transferring data in cells or packets of a fixed size, where ATM creates a fixed channel or route between two points whenever data transfer begins.

The bit interleaved parity 32 (BIP-32) 629, a 4-byte field, is used for monitoring the bit error ratio (BER) on the transmission link for transporting the data. Parity checking is the use of parity bits to check that the data have been transmitted accurately. The parity bit (e.g., BIP 32) is added to every data unit being transmitted. Each of the bits of the BIP-32 is the result of an exclusive-or (XOR) operation of all the same position bits in all the payload field which includes the padding bytes in the padding 627 prior to scrambling.

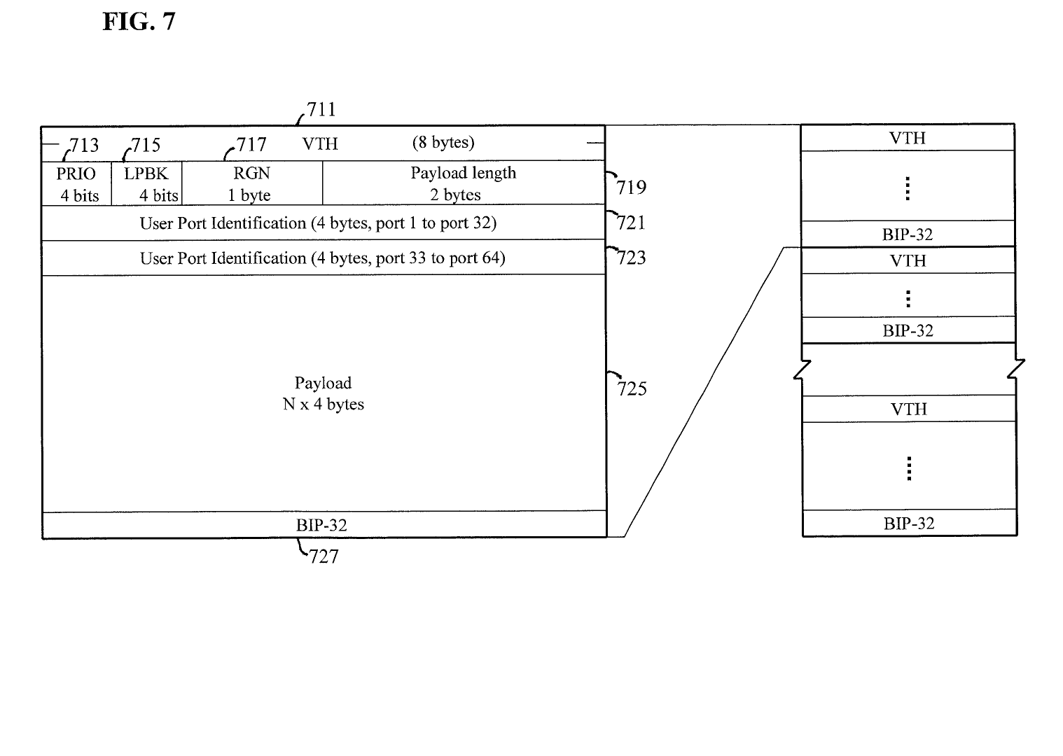

FIG. 7 is a diagram that illustrates the voice TDMA channel 507 for an upstream data frame according to the invention. The voice TDMA channel 507, an M×4-byte field where M is an integer, is used to transport the local call voice data packets to the OLT 100. The voice TDMA channel 507 comprises a plurality of fields including the voice TDMA header (VTH) 711, the priority (PRIO) 713, the loopback (LPBK) 715, the residential gateway number (RGN) 717, the payload length 719, the user port identifications 721 and 723, the payload 725 and the bit interleaved parity 32 (BIP-32) 727.

The VTH 711, an 8-byte field (8D, F6, 8D, 28 in hexadecimal), indicates the start of the voice TDMA channel 507. The PRIO 713, a 4-bit field, defines the priority level of the data packets with respect to data traffic flow. The LPBK 715, a 4-bit field, defines the loopback function for the data packets of the voice TDMA channel 507.

The RGN 717, a 1-byte field, identifies the residential gateway connected to a particular ONU. A gateway is a combination of hardware and software that links two different types of networks, i.e., the PON and the particular ONU at the residence for an end user. The payload length 719, a 2-byte field, defines the total payload length for the data packets of the voice TDMA channel 507. The payload length 719 includes payload only, not the bytes of the bit interleaved parity 32 (BIP-32) 727.

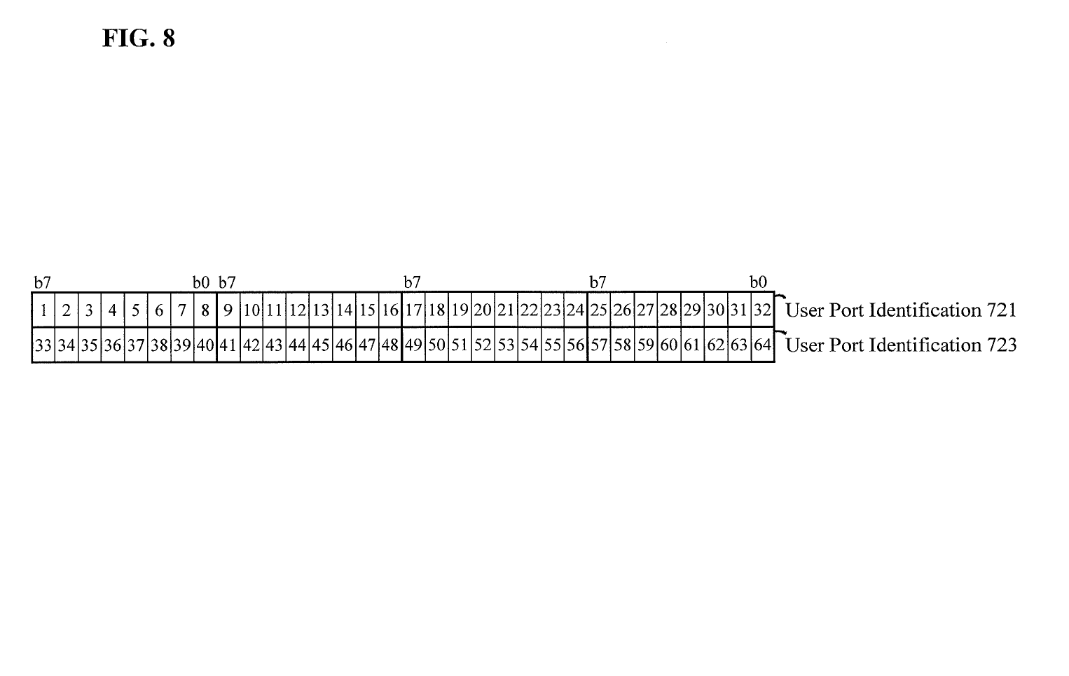

The user port identifications 721 and 723, having a total of 4 bytes, identify the corresponding user port of one voice group of the Media Gateway Control Protocol (MGCP). MGCP is a protocol that controls gateways of the voice over Internet protocol (VOIP) on external call control elements. MGCP assumes a call control architecture where the call control intelligence is outside the gateways and handled by external call control elements. A port identifies an end user's or subscriber's voice channel that corresponds to a telephone number of that end user or subscriber. The maximum number of user ports defined under the MGCP protocol is 64 so that 8 bytes identify 64 end users where each bit corresponds to a single end user. FIG. 8 is a diagram that illustrates the relationship between the bit position and the port number in the user port identifications 721 and 723, where the first received bit (b7) of the first received byte is port number 1.

The payload 725, a field of N×4′bytes where N is an integer, contains the voice data packets of the voice TDMA channel 507. The voice data packets are arranged in the field of the payload 725 in sequential fashion from user port 1 to port 64 according to the logical level of the corresponding bit positions for the user ports. If the logical level of the bit position is 1, then the voice data packets are put in the field of the payload 725. If the logical level of the bit position is 0, then there is no voice data packet in the field of the payload 725.

The bit interleaved parity 32 (BIP-32) 727, a 4-byte field, is used for monitoring the bit error ratio (BER) on the transmission link for transporting the data. Each of the bits of the BIP-32 is the result of an exclusive-or (XOR) operation of all the same position bits in all the payload field prior to scrambling.

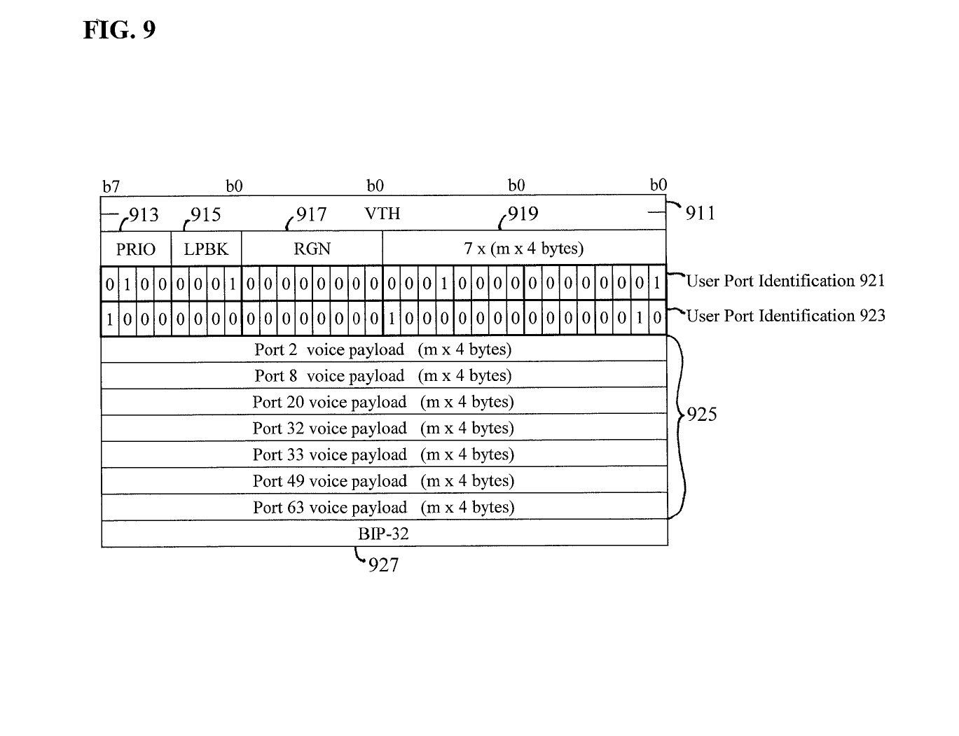

FIG. 9 is a diagram that illustrates an exemplary data structure of the voice TDMA channel 507. The exemplary data structure for the voice TDMA channel 507 comprises a plurality of fields including the voice TDMA header (VTH) 911, the priority (PRIO) 913, the loopback (LPBK) 915, the residential gateway number (RGN) 917, the payload length 919, the user port identifications 921 and 923, the payload 925 and the bit interleaved parity 32 (BIP-32) 927. The fields 921 and 923 identify the corresponding user port of one voice group of 64 end users, where each bit refers to a single end user. The field of the payload 925 includes the voice payload for user ports 2, 8, 20, 32, 33, 49 and 63.

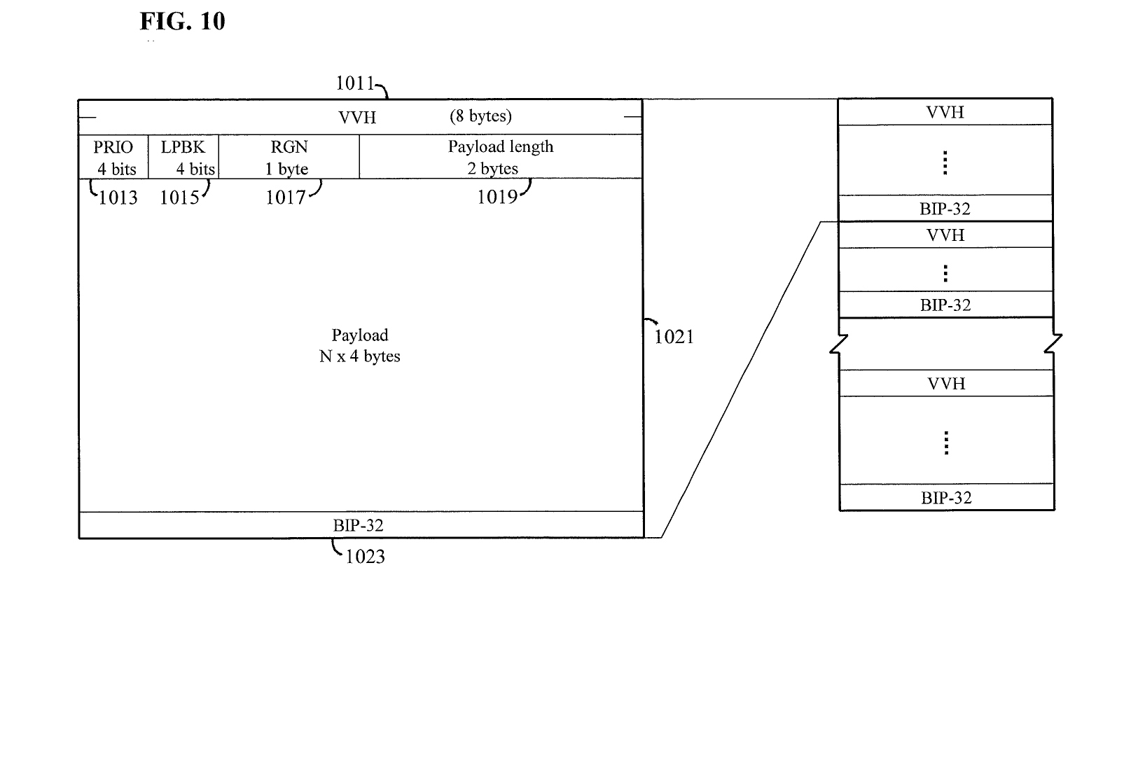

FIG. 10 is a diagram that illustrates the voice VOIP channel 508. The voice VOIP channel 508, an M×4-byte field, is used to transport long distance call data packets to the PSTN or the IP network 200. The voice VOIP channel 508 comprises a plurality of fields including the voice VOIP header (VVH) 1011, the priority (PRIO) 1013, the loopback (LPBK) 1015, the residential gateway number (RGN) 1017, the payload length 1019, the payload 1021 and the bit interleaved parity 32 (BIP-32) 1023.

The VVH 1011, an 8-byte field (8C, F6, 8D, 28 in hexadecimal), indicates the start of the voice VOIP channel 508. The PRIO 1013, a 4-bit field, defines the priority level of the data packets with respect to data traffic flow. A value of 0 represents the lowest priority. A value of 15 (or F in hexadecimal) represents the highest priority.

The LPBK 1015, a 4-bit field, defines the loopback function for the data packets of the voice VOIP channel 508. The RGN 1017, a 1-byte field, identifies the residential gateway connected to a particular ONU. The payload length 1019, a 2-byte field, defines the total payload length for the IP packetized voice packets of the voice VOIP channel 508. The payload length 1019 includes payload only, not the bytes of the bit interleaved parity 32 (BIP-32) 1023. The payload 1021, a field of N×4 bytes where N is an integer, contains the IP packetized voice packets of the voice VOIP channel 508.

The bit interleaved parity 32 (BIP-32) 1023, a 4-byte field, is used for monitoring the bit error ratio (BER) on the transmission link for transporting the data. Each of the bits of the BIP-32 is the result of an exclusive-or (XOR) operation of all the same position bits in all the payload field prior to scrambling.

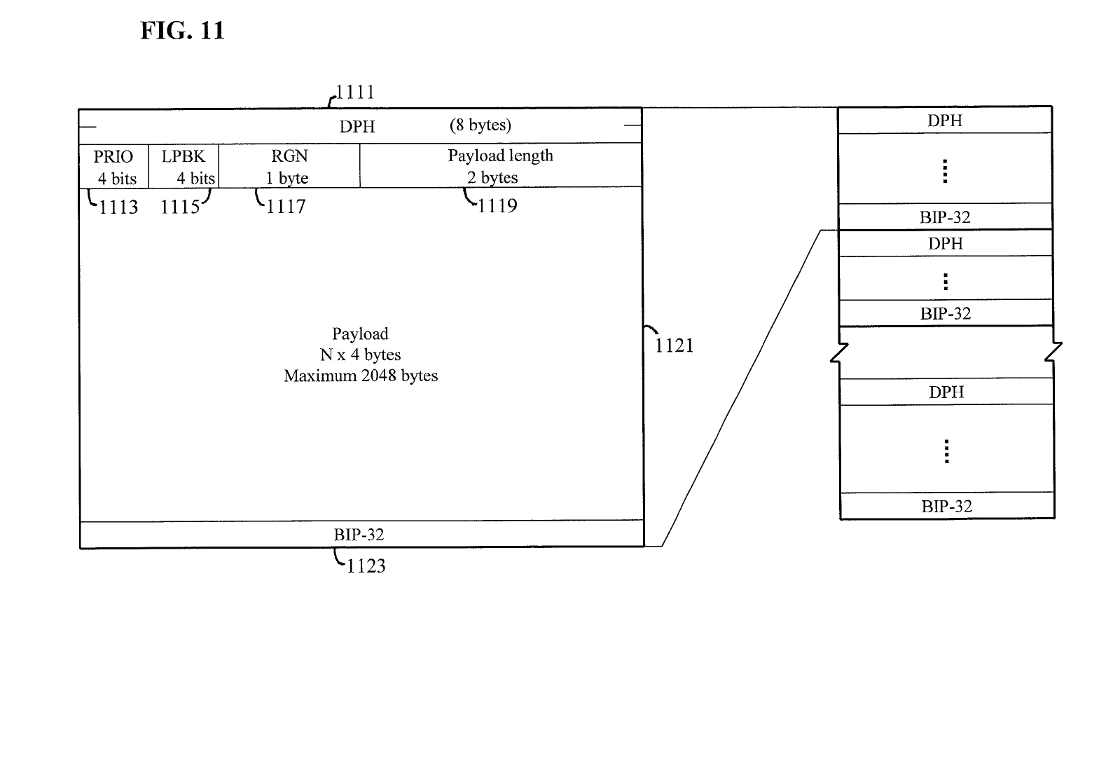

FIG. 11 is a diagram that illustrates the upstream data packet channel 509. The upstream data packet channel 509, an M×4-byte field where M is an integer, is used to transport the data packets with lower priority (such as computer data files or image pictures) to the OLT 100 or the IP network 200. The upstream data packet channel 509 comprises a plurality of fields including the data packet header (DPH) 1111, the priority (PRIO) 1113, the loopback (LPBK) 1115, the residential gateway number (RGN) 1117, the payload length 1119, the payload 1121 and the bit interleaved parity 32 (BIP-32) 1123.

The DPH 1111, an 8-byte field (8B, F6, 8D, 28 in hexadecimal), indicates the start of the upstream data packet channel 509. PRIO 1113, a 4-bit field, defines the priority level of the data packets with respect to data traffic flow. A value of 0 represents the lowest priority with respect to the traffic flow. A value of 15 (or F in hexadecimal) represents the highest priority.

The LPBK 1115, a 4-bit field, defines the loopback function for the data packets of the upstream data packet channel 509. The RGN 1117, a 1-byte field, identifies the residential gateway connected to a particular ONU. The payload length 1119, a 2-byte field, defines the total payload length for the data packets of the upstream data packet channel 509. The payload length 1119 includes payload only, not the bytes of the bit interleaved parity 32 (BIP-32) 1023. The payload 1121, a field of N×4 bytes where N is an integer, contains the data packets of the upstream data packet channel 508. The maximum payload length of each data packet is 2048 bytes.

The bit interleaved parity 32 (BIP-32) 1123, a 4-byte field, is used for monitoring the bit error ratio (BER) on the transmission link for transporting the data. Each of the bits of the BIP-32 is the result of an exclusive-or (XOR) operation of all the same position bits in all the payload field prior to scrambling.

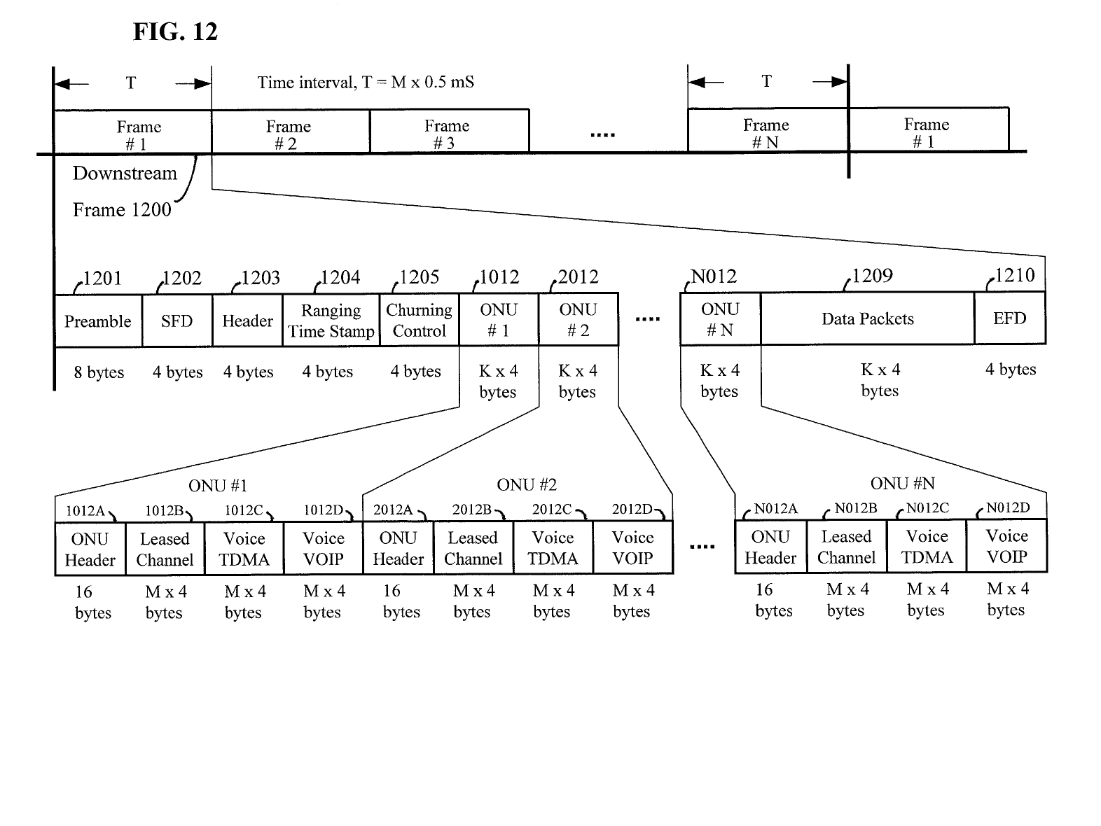

FIG. 12 is a diagram illustrating a downstream data frame corresponding to the upstream frame 500 for carrying data or information downstream from OLT 100 to the ONUs (ONU 1, 2, 3, 4, . . . and N) in accordance with the invention. The data being transported downstream from the OLT 100 to the ONUs include 1, 2, 3, . . . and N frames, one for each ONU in the PON. The time interval T for each of the frames is M×0.5 milliseconds (ms). Particularly shown in FIG. 12 is the downstream data frame 1200 for carrying data or information downstream from the OLT 100 to the ONUs (1, 2, 3, . . . and N) in accordance with the invention.

The downstream data frame 1200 comprises a plurality of fields, including a downstream preamble 1201, a downstream start frame delimiter (SFD) 1202, a downstream header 1203, a downstream ranging time stamp 1204, a churning control 1205, a downstream data packet channel 1209, and a downstream end frame delimiter (EFD) 1210. In addition, according to the invention the downstream data frame 1200 comprises N fields (1012, 2012, 3012, . . . and N012) for the ONUs 1, 2, 3, . . . N, respectively.

The preamble 1201 contains 8 bytes (64 bits) of alternating 1s and 0s that alert each of the ONUs to the coming downstream frame 1200 and enables the synchronization of its timing. The SFD 1202, at 4 bytes, is used as a frame alignment signal to indicate the start of the downstream frame 1200.

The header 1203 is used for the system control of the PON that identifies the OLT 100 from which the data are being transmitted and specifies the unused bandwidth available for the PON. The header 1203 includes an OLT identifier (1 byte) that indicates the OLT number on the PON (i.e., OLT 100), another byte K1 used for the protection switch and automatic ranging functions for the PON, and an unused bandwidth (UBW) field of 2 bytes with automatic bandwidth adjustment.

The ranging time stamp 1204 (4 bytes) is used to send the ranging time clock to each of the ONUs. The ONU 1, for instance, copies the ranging time clock received from the OLT 100 and stores it into the ranging time stamp 1204 for the ONU 1. In accordance with the invention, the OLT 100 calculates the timing difference (i.e., the round trip time) between the receiving time, the ranging time stamp received from the ONU 1, and the time of the ranging time stamp for adjusting the guard time between two ONUs, e.g., the ONUs 1 and 2. The ranging time stamp 1204 can also be used for automatic bandwidth adjustment. For example, in the present embodiment of the invention, if the sending time is 212 μS for a frame sent from the OLT then copied back to the OLT by the ONU, with the receiving time at 378 μS, the round trip time is 378 minus 212 which is 166 μS.

The churning control 1205 (4 bytes) is used for the churning function of the PON and performing the new churning key request. Churning refers to the encryption of transmission channels in the art.

The downstream data packet channel 1209, a K×4-byte field where K is an integer, is used to transport the data packets with lower priority (such as computer data files or image pictures) over the IP network 200 to a particular ONU. The maximum payload length of each data packet in the channel 1209 is 2048 bytes. The structure of the downstream data packet channel is generally the same as the upstream data packet channel 509 shown in FIG. 11. The end frame delimiter (EFD) 1210, a 4-byte field (9E, 9E, 9E and 9E in hexadecimal) is used as a frame termination signal to indicate the end of the downstream frame 1200.

The downstream data frame 1200 also comprises N fields (1012, 2012, 3012, . . . and N012) for the ONUs 1, 2, 3, . . . N, respectively, which are described in further detail below. Particularly shown in FIG. 12 is the field 1012 (with K×4 bytes where K is an integer) for the ONU 1 comprising four fields, namely the ONU header 1012A, leased channel 1012B, voice TDMA channel 1012C and voice VOIP channel 1012D. The structure of the fields 2012, 3012, . . . and N012 for the other ONUs (i.e., ONU 2, 3, . . . and N, respectively) is generally the same as that of the field 1012 for ONU 1. The fields 1012, 2012, 3012, . . . and N012 for the ONUs 1, 2, 3, . . . and N are used for transporting the data packets with higher priority from the OLT 100 to the ONUs. Each of these fields comprise an ONU header (e.g., ONU header 1012A), a leased channel (e.g., leased channel 1012B), a voice time division multiple access (TDMA) channel (e.g., voice TDMA channel 1012C), and a voice over Internet protocol (VOIP) channel (e.g., voice VOIP channel 1012D).

With reference to ONU 1 in particular, the field 1012 comprises the ONU header 1012A, leased channel 1012B, voice TDMA channel 1012C, and voice VOIP channel 1012D. The leased channel 1012B is a M×4-byte field (M being an integer) which is used to transport data, such as time division multiplexing (TDM) or IP data from the OLT 100, the PSTN or the IP network 200 to a particular ONU. The structure of the leased channel 1012B is generally the same as that of the leased channel 506 for the upstream data frame 500 shown in FIGS. 5 and 6. The voice TDMA channel 1012C, an M×4-byte field where M is an integer, is used to transport local call voice data packets to a particular ONU. The structure of the voice TDMA channel 1012C is generally the same as that of the voice TDMA channel 507 for the upstream data frame 500 shown in FIGS. 5, 7, 8 and 9. The voice VOIP channel 1012D, an M×4-byte field, is used to transport long distance call data packets from the Public Switched Telephone Network (PSTN) or the IP network 200 to a particular ONU. The structure of the voice VOIP channel 1012D is generally the same as that of the voice VOIP channel 508 for the upstream data frame 500 shown in FIGS. 5 and 10.

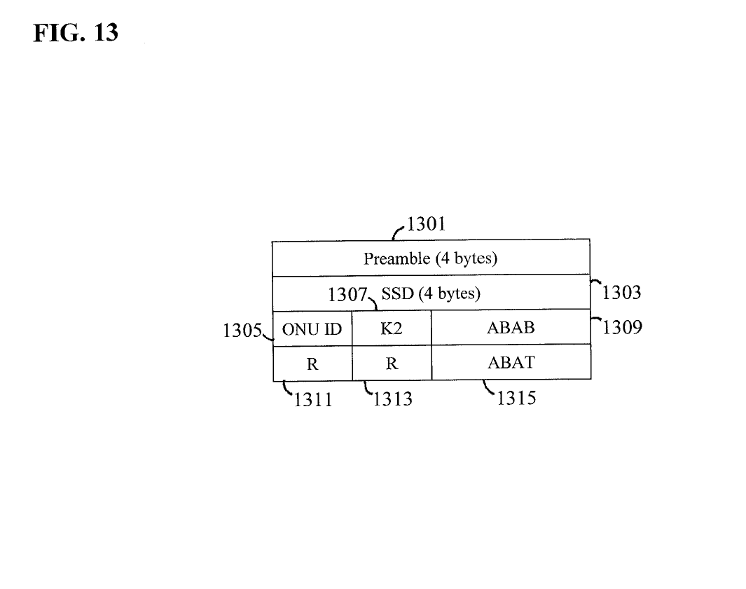

FIG. 13 is a diagram that illustrates an exemplary ONU header (e.g., the ONU header 1012A) for the downstream data frame 1200 according to the invention. The ONU header 1012A, a 16-byte field, is used to indicate the start of each of the ONU fields, which is also used for bandwidth adjustment for each ONU. The structure of the other ONU headers 2012A, 3012A, . . . and N for the other ONUs 2, 3, . . . and N, respectively, is generally the same as that of the ONU header 1012A for the ONU 1.

The ONU header 1012A comprises a plurality of fields comprising a preamble 1301, start sub-frame delimiter (SSD) 1303, ONU ID 1305, automatic bandwidth adjustment beginning (ABAB) 1309, automatic bandwidth adjustment terminating (ABAT) 1315, reserved fields K2 (1307), R (1311) and R (1313). The preamble 1301, a 4-byte field of alternating 1s and 0s (AA, AA, AA, AA in hexadecimal), alerts the ONU 1 of the coming ONU field of the downstream data frame 1200 and enables the synchronization of its timing. The SSD 1303, a 4-byte field (6F, F6, 6F, 28 in hexadecimal) is used as a frame alignment signal to indicate the start of the subframe or ONU field for ONU 1, namely the field 1012. The ONU ID 1305 is used to indicate the ONU number (i.e., ONU 1) on the PON. The ABAB 1309 and ABAT 1315 are used for performing automatic bandwidth adjustment for the PON.

Although the invention has been particularly shown and described in detail with reference to the preferred embodiments thereof, the embodiments are not intended to be exhaustive or to limit the invention to the precise forms disclosed herein. It will be understood by those skilled in the art that many modifications in form and detail may be made without departing from the spirit and scope of the invention. Similarly, any process steps described herein may be interchangeable with other steps to achieve substantially the same result. All such modifications are intended to be encompassed within the scope of the invention, which is defined by the following claims and their equivalents.

I/We claim:

1. A passive optical network (PON) connected to an Internet protocol (IP) network, the PON comprising:
an optical line terminal (OLT);
a plurality of optical network units (ONUs) connected to the OLT;
an upstream frame for transmitting data from one of the ONUs to the OLT, the upstream frame comprising:
an upstream preamble alerting the OLT of the upstream frame;
an upstream start frame delimiter (SFD) indicating a start of the upstream frame;
an upstream header indicating the ONU from which the upstream frame is transmitted;
an upstream ranging time stamp responding to a ranging time clock sent from the OLT;
a churning key performing churning for the PON;
an upstream leased channel transporting data to the OLT;
an upstream voice time division multiple access (TDMA) channel transporting local call voice data to the OLT;
an upstream voice over Internet protocol (VOIP) channel transporting long distance call voice data to the IP network;
an upstream data packet channel transporting data packets to the IP network; and
an upstream end frame delimiter (EFD) indicating an end of the upstream frame.

2. The passive optical network (PON) of claim 1 further comprising:
a downstream frame for transmitting data from the OLT to the ONUs, the downstream frame comprising:
a downstream preamble alerting the ONUs of the downstream frame;
a downstream start frame delimiter (SFD) indicating a start of the downstream frame;
a downstream header indicating the OLT from which the downstream frame is transmitted;
a downstream ranging time stamp sending a ranging time clock to the ONUs;
a churning control performing a churning key request for the PON;
a downstream data packet channel transporting data packets from the IP network to the ONUs;
a downstream end frame delimiter (EFD) indicating an end of the downstream frame; and
a plurality of ONU fields corresponding to each of the ONUs, each ONU field comprising:
(a) an ONU header indicating a start of the ONU field;
(b) a leased channel transporting data to the ONU corresponding to the ONU field;
(c) a voice time division multiple access (TDMA) channel transporting local call voice data to the ONU corresponding to the ONU field; and
(d) a voice over Internet protocol (VOIP) channel transporting long distance call voice data from the IP network to the ONU corresponding to the ONU field.

3. The passive optical network (PON) of claim 1 wherein the upstream leased channel includes a plurality of fields comprising:
a leased channel header indicating the start of the upstream leased channel;
a priority defining a priority level and a payload type for transmitting the data;
a loopback defining a loopback function of the upstream leased channel;
a payload length defining a total payload length of the upstream leased channel;
a source address identifying an original source of the data;
a destination address identifying a final destination of the data;
a payload for transporting time division multiplexing (TDM) data packets;
a padding for meeting requirements of the payload; and
a bit interleaved parity for monitoring a bit error ratio (BER) for transmitting the data.

4. The PON of claim 3 wherein:
the source address is an Internet protocol (IP) address identifying one of the ONUs or the IP network; and
the destination address is an IP address identifying the IP network.

5. The PON of claim 3 wherein the source address is an Internet protocol (IP) address and the destination address includes an IP address of one selected from the group consisting of the OLT, the ONUs, the IP network, other OLT and ONUs of another PON.

6. The PON of claim 1 further comprising a plurality of frames wherein each frame includes a frame structure that is generally the same as that of the upstream frame.

7. The PON of claim 6 wherein two of the plurality of frames are separated by a guard time.

8. The PON of claim 1 wherein the upstream voice TDMA channel includes a plurality of fields comprising:
a voice TDMA header indicating the start of the upstream voice TDMA channel;
a priority defining a priority level for transmitting the data;
a loopback defining a loopback function of the upstream voice TDMA channel;
a residential gateway number identifying a residential gateway connected to one of the ONUs;
a payload length defining a total payload length of the voice TDMA channel;
at least one user port identification identifying a corresponding user port of one voice group;
a payload including voice data packets of the voice TDMA channel; and
a bit interleaved parity parity for monitoring a bit error ratio (BER) for transmitting the data.

9. The PON of claim 8 wherein the voice data packets of the upstream voice TDMA channel are arranged in the payload in sequential fashion in a plurality of user ports according to a logical level of corresponding bit positions for the user ports.

10. The PON of claim 1 wherein the upstream voice VOIP channel includes a plurality of fields comprising:
a voice VOIP header indicating the start of the upstream voice VOIP channel;
a priority defining a priority level for transmitting the data;
a loopback defining a loopback function of the upstream voice VOIP channel;
a residential gateway number identifying a residential gateway connected to one of the ONUs;
a payload length defining a total payload length of the voice VOIP channel;
a payload including IP packetized voice data packets of the voice VOIP channel; and
a bit interleaved parity for monitoring a bit error ratio (BER) for transmitting the data.

11. The PON of claim 1 wherein the upstream data packet channel includes a plurality of fields comprising:
a data packet header indicating the start of the upstream data packet channel;
a priority defining a priority level for transmitting the data;
a loopback defining a loopback function of the upstream data packet channel;
a residential gateway number identifying a residential gateway connected to one of the ONUs;
a payload length defining a total payload length of the upstream data packet channel;
a payload including data packets of the upstream data packet channel; and
a bit interleaved parity for monitoring a bit error ratio (BER) for transmitting the data.

12. The PON of claim 2 wherein each of the ONU fields further comprises:
an ONU header preamble alerting the ONU corresponding to the ONU header of the ONU field;
an ONU start subframe delimiter (SSD) indicating a start of the ONU field;
an ONU identifier indicating an ONU number; and
an automatic bandwidth adjustment beginning (ABAB) and an automatic bandwidth adjustment terminating (ABAT) for performing automatic bandwidth adjustment for the PON.

13. The PON of claim 2 wherein the downstream leased channel includes a plurality of fields comprising:
a leased channel header indicating the start of the downstream leased channel;
a priority defining a priority level and a payload type for transmitting the data;
a loopback defining a loopback function of the downstream leased channel;
a payload length defining a total payload length of the downstream leased channel;
a source address identifying an original source of the data;
a destination address identifying a final destination of the data;
a payload for transporting time division multiplexing (TDM) data packets or IP data packets;
a padding for meeting requirements of the payload; and
a bit interleaved parity for monitoring a bit error ratio (BER) for transmitting the data.

14. The PON of claim 13 wherein:
the source address is an Internet protocol (IP) address identifying one selected from the group consisting of the OLT, the ONUs, the IP network, other OLT and ONUs of another PON; and
the destination address is an IP address identifying the IP network.

15. The PON of claim 13 wherein the source address is an Internet protocol (IP) address and the destination address includes an IP address of the ONUs or the IP network.

16. The PON of claim 2 further comprising a plurality of frames wherein each frame includes a frame structure that is generally the same as that of the downstream frame.

17. The PON of claim 2 wherein the downstream voice TDMA channel includes a plurality of fields comprising:
a voice TFDMA header indicating the start of the downstream voice TDMA channel;
a priority defining a priority level for transmitting the data;
a loopback defining a loopback function of the downstream voice TDMA channel;
a residential gateway number identifying a residential gateway connected to one of the ONUs;
a payload length defining a total payload length of the voice TDMA channel;
at least one user port identification identifying a corresponding user port of one voice group;
a payload including voice data packets of the voice TDMA channel; and
a bit interleaved parity parity for monitoring a bit error ratio (BER) for transmitting the data.

18. The PON of claim 17 wherein the voice data packets of the downstream voice TDMA channel are arranged in the payload in sequential fashion in a plurality of user ports according to a logical level of corresponding bit positions for the user ports.

19. The PON of claim 2 wherein the downstream voice VOIP channel includes a plurality of fields comprising:
a voice VOIP header indicating the start of the downstream voice VOIP channel;
a priority defining a priority level for transmitting the data;
a loopback defining a loopback function of the downstream voice VOIP channel;
a residential gateway number identifying a residential gateway connected to one of the ONUs;
a payload length defining a total payload length of the voice VOIP channel;
a payload including IP packetized voice data packets of the voice VOIP channel; and
a bit interleaved parity for monitoring a bit error ratio (BER) for transmitting the data.

20. The PON of claim 2 wherein the downstream data packet channel includes a plurality of fields comprising:
a data packet header indicating the start of the downstream data packet channel;
a priority defining a priority level for transmitting the data;
a loopback defining a loopback function of the downstream data packet channel;
a residential gateway number identifying a residential gateway connected to one of the ONUs;
a payload length defining a total payload length of the downstream data packet channel;
a payload including data packets of the downstream data packet channel; and
a bit interleaved parity for monitoring a bit error ratio (BER) for transmitting the data.

21. A method for a passive optical network (PON) connected to an Internet protocol (IP) network, wherein the PON comprises an optical line terminal (OLT) and a plurality of optical network units (ONUs) connected to the OLT, and an upstream frame for transmitting data in an upstream from one of the ONUs to the OLT and a downstream frame for transmitting data in a downstream from the OLT to the ONUs, the method comprising the steps of:
sending in the upstream an upstream preamble alerting the OLT of the upstream frame;
sending in the upstream an upstream start frame delimiter (SFD) indicating a start of the upstream frame;
sending in the upstream an upstream header indicating the ONU from which the upstream frame is transmitted;
sending in the upstream an upstream ranging time stamp responding to a ranging time clock sent from the OLT;
sending in the upstream a churning key performing churning for the PON;
sending in the upstream an upstream leased channel transporting data to the OLT;
sending in the upstream an upstream voice time division multiple access (TDMA) channel transporting local call voice data to the OLT;
sending in the upstream an upstream voice over Internet protocol (VOIP) channel transporting long distance call voice data to the IP network;
sending in the upstream an upstream data packet channel transporting data packets to the IP network; and
sending in the upstream an upstream end frame delimiter (EFD) indicating an end of the upstream frame.

22. The method claim 21 further comprising the steps of:
sending in the downstream a downstream preamble alerting the ONU of the downstream frame;
sending in the downstream a downstream start frame delimiter (SFD) indicating a start of the downstream frame;
sending in the downstream a downstream header indicating the OLT from which the downstream frame is transmitted;
sending in the downstream a downstream ranging time stamp sending a ranging time clock to the ONUs;
sending in the downstream a churning control performing a churning key request for the PON;
sending in the downstream a downstream data packet channel transporting data packets from the IP network to the ONUs;
sending in the downstream a downstream end frame delimiter (EFD) indicating an end of the downstream frame;
sending in the downstream a plurality of ONU fields corresponding to each of the ONUs; wherein the method further comprises the steps of:
(a) sending in each of the ONU fields an ONU header indicating a start of the ONU field;
(b) sending in each of the ONU fields a leased channel transporting data to the ONU corresponding to the ONU field;
(c) sending in each of the ONU fields a voice time division multiple access (TDMA) channel transporting local call voice data to the ONU corresponding to the ONU field; and
(d) sending in each of the ONU fields a voice over Internet protocol (VOIP) channel transporting long distance call voice data from the IP network to the ONU corresponding to the ONU field.

23. The method of claim 21 further comprising the steps of:
sending in the upstream leased channel a leased channel header indicating the start of the upstream leased channel;
sending in the upstream leased channel a priority defining a priority level and a payload type for transmitting the data;
sending in the upstream leased channel a loopback defining a loopback function of the upstream leased channel;
sending in the upstream leased channel a payload length defining a total payload length of the upstream leased channel;
sending in the upstream leased channel a source address identifying an original source of the data;
sending in the upstream leased channel a destination address identifying a final destination of the data;
sending in the upstream leased channel a payload for transporting time division multiplexing (TDM) data packets;
sending in the upstream leased channel a padding for meeting requirements of the payload; and
sending in the upstream leased channel a bit interleaved parity for monitoring a bit error ratio (BER) for transmitting the data.

24. The method of claim 23 wherein:
the source address is an Internet protocol (IP) address identifying one of the ONUs or the IP network; and
the destination address is an IP address identifying the IP network.

25. The method of claim 23 wherein the source address is an Internet protocol (IP) address and the destination address includes an IP address of one selected from the group consisting of the OLT, the ONUs, the IP network, other OLT and ONUs of another PON.

26. The method of claim 21 further comprising the step of sending in the upstream a plurality of frames wherein each frame includes a frame structure that is generally the same as that of the upstream frame.

27. The method of claim 26 wherein two of the plurality of frames are separated by a guard time.

28. The method of claim 21 further comprising the steps of:
sending in the upstream voice TDMA channel a voice TDMA header indicating the start of the upstream voice TDMA channel;
sending in the upstream voice TDMA channel a priority defining a priority level for transmitting the data;
sending in the upstream voice TDMA channel a loopback defining a loopback function of the upstream voice TDMA channel;
sending in the upstream voice TDMA channel a residential gateway number identifying a residential gateway connected to one of the ONUs;
sending in the upstream voice TDMA channel a payload length defining a total payload length of the voice TDMA channel;
sending in the upstream voice TDMA channel at least one user port identification identifying a corresponding user port of one voice group;
sending in the upstream voice TDMA channel a payload including voice data packets of the voice TDMA channel; and
sending in the upstream voice TDMA channel a bit interleaved parity parity for monitoring a bit error ratio (BER) for transmitting the data.

29. The method of claim 28 wherein the voice data packets of the upstream voice TDMA channel are arranged in the payload in sequential fashion in a plurality of user ports according to a logical level of corresponding bit positions for the user ports.

30. The method of claim 21 further comprising the steps of:
sending in the upstream voice VOIP channel a voice VOIP header indicating the start of the upstream voice VOIP channel;
sending in the upstream voice VOIP channel a priority defining a priority level for transmitting the data;
sending in the upstream voice VOIP channel a loopback defining a loopback function of the upstream voice VOIP channel;
sending in the upstream voice VOIP channel a residential gateway number identifying a residential gateway connected to one of the ONUs;
sending in the upstream voice VOIP channel a payload length defining a total payload length of the voice VOIP channel;
sending in the upstream voice VOIP channel a payload including IP packetized voice data packets of the voice VOIP channel; and
sending in the upstream voice VOIP channel a bit interleaved parity for monitoring a bit error ratio (BER) for transmitting the data.

31. The method of claim 21 further comprising the steps of:
sending in the upstream data packet channel a data packet header indicating the start of the upstream data packet channel;
sending in the upstream data packet channel a priority defining a priority level for transmitting the data;
sending in the upstream data packet channel a loopback defining a loopback function of the upstream data packet channel;
sending in the upstream data packet channel a residential gateway number identifying a residential gateway connected to one of the ONUs;
sending in the upstream data packet channel a payload length defining a total payload length of the upstream data packet channel;
sending in the upstream data packet channel a payload including data packets of the upstream data packet channel; and
sending in the upstream data packet channel a bit interleaved parity for monitoring a bit error ratio (BER) for transmitting the data.

32. The method of claim 22 further comprising the steps of:
sending in each of the ONU fields an ONU header preamble alerting the ONU corresponding to the ONU header of the ONU field;
sending in each of the ONU fields an ONU start subframe delimiter (SSD) indicating a start of the ONU field;
sending in each of the ONU fields an ONU identifier indicating an ONU number; and
sending in each of the ONU fields an automatic bandwidth adjustment beginning (ABAB) and an automatic bandwidth adjustment terminating (ABAT) for performing automatic bandwidth adjustment for the PON.

33. The method of claim 22 further comprising the steps of:
sending in the downstream leased channel a leased channel header indicating the start of the downstream leased channel;
sending in the downstream leased channel a priority defining a priority level and a payload type for transmitting the data;
sending in the downstream leased channel a loopback defining a loopback function of the downstream leased channel;
sending in the downstream leased channel a payload length defining a total payload length of the downstream leased channel;
sending in the downstream leased channel a source address identifying an original source of the data;
sending in the downstream leased channel a destination address identifying a final destination of the data;
sending in the downstream leased channel a payload for transporting time division multiplexing (TDM) data packets or IP data packets;
sending in the downstream leased channel a padding for meeting requirements of the payload; and
sending in the downstream leased channel a bit interleaved parity for monitoring a bit error ratio (BER) for transmitting the data.

34. The method of claim 33 wherein:
the source address is an Internet protocol (IP) address identifying one selected from the group consisting of the OLT, the ONUs, the IP network, other OLT and ONUs of another PON; and
the destination address is an IP address identifying the IP network.

35. The method of claim 33 wherein the source address is an Internet protocol (IP) address and the destination address includes an IP address of the ONUs or the IP network.

36. The method of claim 22 further comprising the step of sending in the downstream a plurality of frames wherein each frame includes a frame structure that is generally the same as that of the downstream frame.

37. The method of claim 22 further comprising the steps of:
sending in the downstream voice TDMA channel a voice TDMA header indicating the start of the downstream voice TDMA channel;
sending in the downstream voice TDMA channel a priority defining a priority level for transmitting the data;
sending in the downstream voice TDMA channel a loopback defining a loopback function of the downstream voice TDMA channel;
sending in the downstream voice TDMA channel a residential gateway number identifying a residential gateway connected to one of the ONUs;
sending in the downstream voice TDMA channel a payload length defining a total payload length of the voice TDMA channel;
sending in the downstream voice TDMA channel at least one user port identification identifying a corresponding user port of one voice group;
sending in the downstream voice TDMA channel a payload including voice data packets of the voice TDMA channel; and
sending in the downstream voice TDMA channel a bit interleaved parity parity for monitoring a bit error ratio (BER) for transmitting the data.

38. The method of claim 37 wherein the voice data packets of the downstream voice TDMA channel are arranged in the payload in sequential fashion in a plurality of user ports according to a logical level of corresponding bit positions for the user ports.

39. The method of claim 22 further comprising the steps of:
sending in the downstream voice VOIP channel a voice VOIP header indicating the start of the downstream voice VOIP channel;
sending in the downstream voice VOIP channel a priority defining a priority level for transmitting the data;
sending in the downstream voice VOIP channel a loopback defining a loopback function of the downstream voice VOIP channel;
sending in the downstream voice VOIP channel a residential gateway number identifying a residential gateway connected to one of the ONUs;
sending in the downstream voice VOIP channel a payload length defining a total payload length of the voice VOIP channel;
sending in the downstream voice VOIP channel a payload including IP packetized voice data packets of the voice VOIP channel; and
sending in the downstream voice VOIP channel a bit interleaved parity for monitoring a bit error ratio (BER) for transmitting the data.

40. The method of claim 22 further comprising the steps of:
sending in the downstream data packet channel a data packet header indicating the start of the downstream data packet channel;
sending in the downstream data packet channel a priority defining a priority level for transmitting the data;
sending in the downstream data packet channel a loopback defining a loopback function of the downstream data packet channel;
sending in the downstream data packet channel a residential gateway number identifying a residential gateway connected to one of the ONUs;
sending in the downstream data packet channel a payload length defining a total payload length of the downstream data packet channel;
sending in the downstream data packet channel a payload including data packets of the downstream data packet channel; and
sending in the downstream data packet channel a bit interleaved parity for monitoring a bit error ratio (BER) for transmitting the data.
